(19) United States
(12) Patent Application Publication
(10) Pub. No.: US 2009/0232502 A1
(43) Pub. Date: Sep. 17, 2009

(54) VISIBLE LIGHT COMMUNICATION SYSTEM AND OPTICAL WIRELESS LAN DEVICE

(76) Inventor: Shinichi Miyashita, Tokyo (JP)

Correspondence Address: Joseph W. Price;SNELL & WILMER L.L.P, Suite 1400, 600 Anton Boulevard, Costa Mesa, CA, 92626, US

(21) Appl. No.: 12/405,048

(22) Filed: Mar. 16, 2009

(30) Foreign Application Priority Data
Mar. 17, 2008 (JP) 2008-68486

(51) Int. Cl. H04J 14/02

(52) U.S. Cl. 398/79

(57) ABSTRACT

A visible light communication system and an optical wireless LAN device are provided, which are capable of establishing a 10 Mbit/s LAN connection by means of an LED lighting unit which integrally has a plurality of LEDs. The optical wireless LAN device 2 has, a visible light transmission unit 202 for converting LAN data into visible light and transmitting same to the terminal device 3, and a light modulation unit 203 which lights an LED 204 constituting a lighting unit using a preset bias current. The LED 204 also has a red LED, a green LED, a blue LED, and a white LED integrally incorporated therein. The red LED performs transmission using visible light by going on and off and implements a 10 Mbit/s LAN connection.

### TECHNICAL FIELD

The present invention relates to a visible light communication system which performs visible light communication by using an LED lighting unit, and more particularly to a visible light communication system allowing a 10 Mbit/s LAN connection (10BASE-T).

### RELATED ART

A wired optical wireless LAN device generally requires wiring. There are therefore dangers which include tripping over the wiring and the problem that this device must be used in low work environments. Hence, an optical wireless LAN device allowing a safe work environment to be secured while obviating the need for wiring has been considered. Optical wireless LAN devices conventionally use radio waves. However, because radio waves affect machinery and medical devices, there is the possibility of radio waves causing such machinery and medical devices to malfunction.

Therefore, in environments where the transmission of radio waves is prohibited or restricted, as in a hospital, a computer room, a machine room, an instrument room, and the like, for example, a visible light communication system which employs not radio waves but visible light as the communication medium has conventionally been proposed (Japanese Patent Application Laid-open No. 2004-221747, for example). The invention of Japanese Patent Application Laid-open No. 2004-221747 uses visible light from LEDs for communication between an optical wireless LAN device being a host device, and a terminal device. In other words, since the responsiveness of an LED is high in comparison with that of an incandescent lamp, mid- to high speed communications using LED lighting are possible.

With a visible light communication system of this kind, communications are carried out only in the range of the visible light of the LED lighting, thereby eliminating the drawbacks of cases where radio waves are employed as mentioned above. Furthermore, because there is no concern over communications leaking to an adjacent room as they do when radio waves are used, there is the advantage that a high security system can be constructed.

Further, white LEDs which use phosphor have become widely popularized in LED lighting. However, with white LEDs, the response speed of phosphor is 10 MHz or less. Hence, 10 Mbit/s communication processing cannot be performed with white LEDs and implementing a high-speed LAN connection such as a 10BASE-T LAN connection is problematic.

### SUMMARY OF INVENTION

The present invention has been proposed in order to solve problems confronted by the prior art of the kind mentioned hereinabove. An object of the present invention is to provide a visible light communication system and an optical wireless LAN device capable of establishing a 10 Mbit/s LAN connection by means of an LED lighting unit which integrally has a plurality of LEDs.

In order to achieve the above object, the present invention is a visible light communication system that has an optical wireless LAN device which performs visible light communication with a terminal device by using visible light from an LED lighting unit, comprising: the optical wireless LAN device having: a light modulation unit which supplies an electric current to the LED lighting unit, a visible light transmission unit which transmits communication data for transmission and reception to the light modulation unit, and the LED lighting unit having incorporated therein a red LED which performs visible light communication by going on and off, and an LED which uses a wavelength which does not interfere with a wavelength used by the red LED.

According to the present invention which has this constitution, by incorporating a red LED and an LED which uses a wavelength which does not interfere with the wavelength used by the red LED into the LED lighting unit of the optical wireless LAN device, a high-speed LAN environment can be constructed by causing the red LED to go on and off and, by providing LEDs of a plurality of types, color rendering can be added to the lighting.

Furthermore, an aspect of the present invention is that, in the data exchange between the terminal device and the optical wireless LAN device, a downlink is established by means of visible light communication and an uplink is established by means of infrared communication. A further aspect of the present invention is that the terminal device and the optical wireless LAN device comprise a light-receiving element used for spatial carrier detection and that communication data is sent and received only when it is confirmed by the light-receiving element that a spatial carrier does not exist.

The present invention makes it possible to construct an optical wireless LAN using visible light which is safe and highly secure by causing the red LED to go on and off, and allows a plurality of people to communicate at the same time. Close links can therefore be implemented between a plurality of workers resulting in improved work efficiency and, because a plurality of LEDs are provided, superior lighting performance can be secured, the lifespan is long in comparison with an incandescent lamp, and a contribution toward lower power consumption is made possible.

### BRIEF DESCRIPTION OF DRAWINGS

FIG. 1 is a constitutional view of a representative embodiment according to the present invention;

FIG. 2 is a block diagram of an optical wireless LAN device and a terminal device according to the embodiment;

FIG. 3 is an example of a flowchart for transmission processing by the optical wireless LAN device according to the embodiment; and

FIG. 4 is an example of a flowchart for reception processing by the optical wireless LAN device according to the embodiment.

### DESCRIPTION OF EMBODIMENTS

An example of an embodiment of the present invention will be described in specific terms hereinbelow with reference to the drawings.

### (1) Constitution of the Embodiment

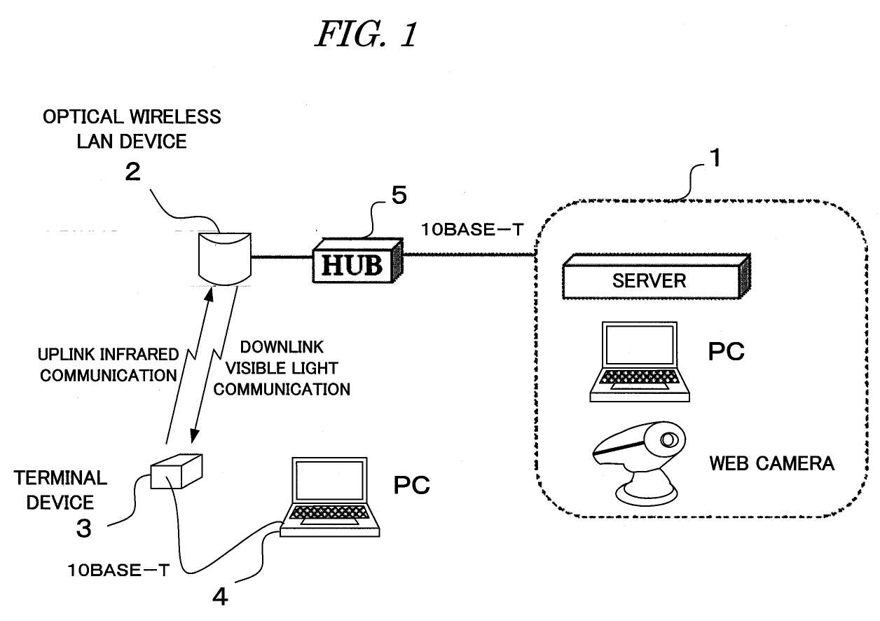

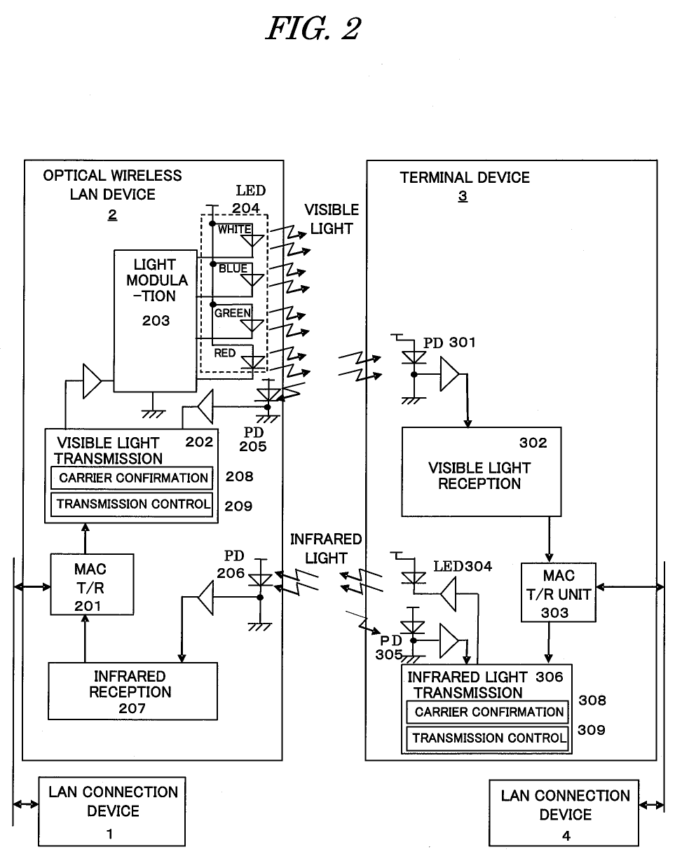

The constitution of a representative embodiment of the present invention will be described in specific terms hereinbelow with reference to FIGS. 1 and 2. FIG. 1 is a constitutional view of the overall constitution of the visible light communication system according to this embodiment and FIG. 2 is a block diagram of an optical wireless LAN device and a terminal device according to the embodiment.

### (1-1) System Overview

This system is constituted by an optical wireless LAN device 2 connected via a HUB 5 to a LAN connection device 1 such as a server, a PC, or a Web camera, a terminal device 3 which performs visible light communication with the optical wireless LAN device 2 via a downlink and infrared communication with the optical wireless LAN device 2 via an uplink, and a LAN connection device 4 such as a PC which is connected to the terminal device 3.

Although only one optical wireless LAN device 2 is connected to the HUB 5 in FIG. 1 for illustration purposes, a larger number of optical wireless LAN devices 2 can also be connected depending on the number of rooms involved in the installation. The number of terminal devices 3 is likewise not limited to the number shown in FIG. 1.

### (1-2) Constitution of Optical Wireless LAN Device

As shown in FIG. 2, the optical wireless LAN device 2 has a MAC transmission/reception unit 201 which sends and receives LAN data from the LAN connection device 1. The optical wireless LAN device 2 further has, in order to implement a function for receiving data from the terminal device 3, a light-receiving element (called a PD: photodiode hereinbelow) PD 206 which receives infrared light having LAN data from the terminal device 3 superposed thereon and converts the infrared light into an electrical signal, and an infrared reception unit 207 which judges whether the infrared light received by the PD 206 is a self-addressed signal and which, in the case of a self-addressed signal, demodulates the signal and sends the signal to the MAC transmission/reception unit 201.

Furthermore, the optical wireless LAN device 2 has, in order to implement a function for transmitting data to the terminal device 3, a visible light transmission unit 202 for receiving LAN data from the MAC transmission/reception unit 201, converting the received LAN data into visible light and transmitting same to the terminal device 3, and a light modulation unit 203 which lights an LED 204 constituting a lighting unit using a preset bias current.

Among these parts, the visible light transmission unit 202 has a carrier confirmation unit 208 which confirms that visible light, which is the carrier, does not exist in a space by means of a visible light PD 205 which the visible light transmission unit 202 has, and a transmission control unit 209 which modulates the LAN data from the MAC transmission/reception unit 201 and transmits the data to the light modulation unit 203.

The LED 204 also has a red LED, a green LED, a blue LED, and a white LED integrally incorporated therein. The red LED performs transmission using visible light by going on and off and implements a 10 Mbit/s LAN connection. The optical wavelength in this case is in a range 620 nm±20 nm (where the wavelength used can be changed depending on the characteristics of the terminal device 3). The green LED, blue LED, and white LED employ wavelengths which do not interfere with the wavelength used by the red LED. The bias current for each LED which is supplied by the light modulation unit 203 is a current value which secures the brightness required for the lighting.

### (1-3) Terminal Device Constitution

As shown in FIG. 2, the terminal device 3 has a MAC transmission/reception unit 303 which sends and receives LAN data from the LAN connection device 4 and has, in order to implement a function for transmitting data to the optical wireless LAN device 2, an infrared transmission unit 306 which transmits the LAN data via an uplink to the optical wireless LAN device 2 by means of infrared light emitted by an LED 304.

The infrared transmission unit 306 has a carrier confirmation unit 308 and a transmission control unit 309. The carrier confirmation unit 308 detects the absence of light which is the carrier in a communication space from infrared light received by the PD 305 which the terminal device 3 has. The transmission control unit 309 modulates LAN data from the MAC transmission/reception unit 303 and causes the LED 304 which emits infrared light to go on and off.

In addition, the terminal device 3 has, in order to implement a function for receiving data from the optical wireless LAN device 2, a PD 301 for receiving visible light having downlink LAN data superposed thereon and a visible light reception unit 302 which converts optical data received by the PD 301 into an electrical signal and transmits the electrical signal to the MAC transmission/reception unit 303.

### (2) Embodiment Operation

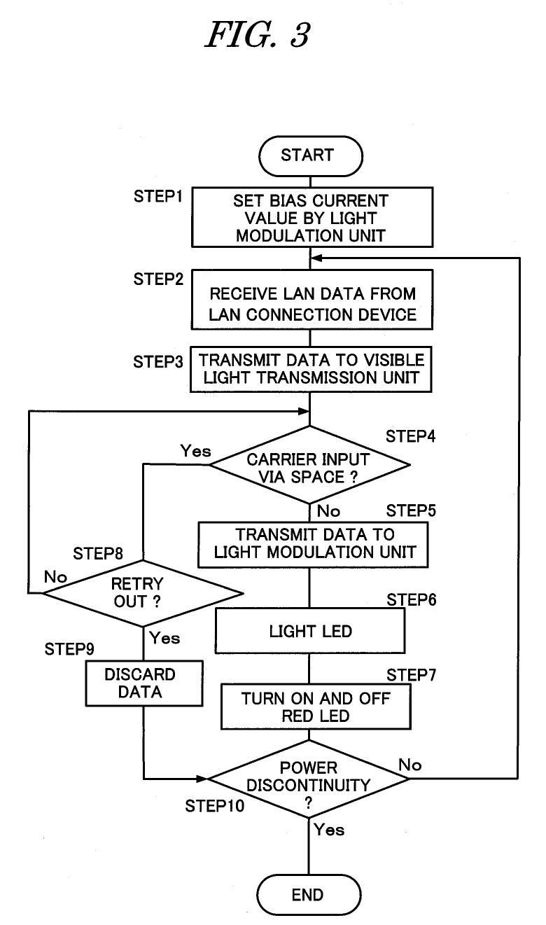

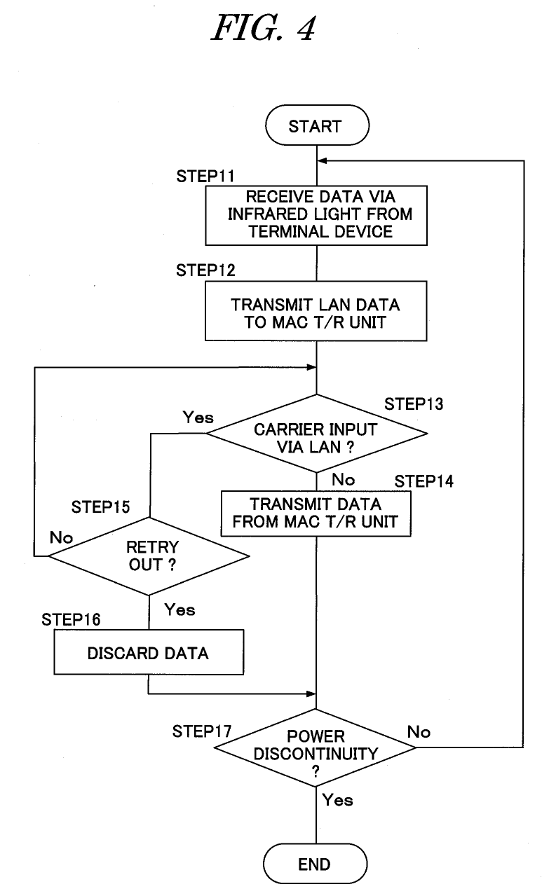

The operation of the embodiment with the above constitution will now be described with reference to the flowcharts of FIGS. 3 and 4.

### (2-1) Transmission Processing of Optical Wireless LAN Device

FIG. 3 is a flowchart showing processing by the optical wireless LAN device 2 for transmission to the terminal device 3. First, a bias current value which is supplied by the light modulation unit 203 to the LED 204 is set in order to establish the brightness which can be used for the LED lighting (step 1). Subsequently, LAN data from the LAN connection device 1 is received by the MAC transmission/reception unit 201 (step 2).

The MAC transmission/reception unit 201 transmits the received data to the visible light transmission unit 202 (step 3). The carrier confirmation unit 208 of the visible light transmission unit 202 confirms light in the visible spectrum (the carrier) which is input by the PD 205 (step 4) and, in cases where there is no input (step 4: CARRIER ABSENT), transmits data to the light modulation unit 203 by means of the transmission control unit 209 (step 5).

The light modulation unit 203 lights the LED 204 with a brightness that is adequate for lighting using a preset bias current (step 6). Here, in cases where the light modulation unit 203 receives data from the visible light transmission unit 202, the red LED of the LED 204 goes on and off and performs transmission using visible light (step 7).

Further, in cases where, upon confirming light (carrier) in the visible spectrum which is input by the PD 205 (step 4), a carrier is present (step 4: CARRIER PRESENT), the carrier confirmation unit 208 of the visible light transmission unit 202 retransmits the data for a random queue time by repeating the light confirmation until a predetermined number of retries is reached (step 8: No).

When the predetermined number of retries is reached (step 8: YES), the data are discarded (step 9). Finally, the transmission control unit 209 of the visible light transmission unit 202 judges whether there is a power discontinuity (step 10), returning to step 2 in the absence of a power discontinuity (step 10: NO) and ending the transmission processing the moment a power discontinuity is judged (step 10: YES).

### (2-2) Terminal Device Reception Processing

The terminal device 3 receives, via the PD 301, a blinking signal from the red LED of the LED 204 which has been transmitted by the optical wireless LAN device 2. The received signal is wave-shaped by the visible light reception unit 302 and then transmitted as data to the MAC transmission/reception unit 303. The MAC transmission/reception unit 303 transmits this LAN data to the LAN connection device 4 by using a LAN protocol.

### (2-3) Terminal Device Transmission Processing

Furthermore, in cases where the terminal device 3 receives LAN data from the LAN connection device 4 by means of the MAC transmission/reception unit 303, the terminal device 3 transmits the received data to the infrared transmission unit 306. The carrier confirmation unit 308 of the infrared transmission unit 306 confirms light in the infrared spectrum (the carrier) which has been input by the PD 305 and, in the absence of an input, transmits data from the transmission control unit 309 to the LED 304. In cases where a carrier is present, the carrier confirmation unit 308 retransmits the data for a random queue time. Here, the data need not be retransmitted and the data may be discarded.

### (2-4) Reception Processing by Optical Wireless LAN Device

FIG. 4 is a flowchart showing processing by the optical wireless LAN device 2 for reception from the terminal device 3. The optical wireless LAN device 2 receives, via the PD 206, an optical signal which is transmitted from the terminal device 3 (step 11). The received signal is wave-shaped by the infrared reception unit 207 and then transmitted as data to the MAC transmission/reception unit 201 (step 12).

The infrared reception unit 207 confirms light in the infrared spectrum (the carrier) on the LAN (step 13). In the absence of an input (step 13: CARRIER ABSENT), the MAC transmission/reception unit 201 transmits LAN data to the LAN connection device 1 by using a LAN protocol (step 14). However, when a carrier is present (step 15: CARRIER PRESENT), the MAC transmission/reception unit 201 retransmits the LAN data for a random queue time by repeating the light confirmation until a predetermined number of retries is reached (step 15: NO).

When the predetermined number of retries is reached (step 15: YES), the data is discarded (step 16). Finally, the MAC transmission/reception unit 201 judges whether there is a power discontinuity (step 17), returning to step 11 in the absence of a power discontinuity (step 17: NO) and ending the transmission processing the moment a power discontinuity is judged (step 17: YES).

### (3) Effect of the Embodiment

As described hereinabove, according to this embodiment, a red LED can be incorporated into the LED 204 of the optical wireless LAN device 2, and a 10 Mbit/s LAN can be implemented by the blinking of visible light by the red LED. Furthermore, because the green LED, blue LED, and white LED in the LED 204 employ wavelengths which do not interfere with the wavelength used by the red LED, there is no concern about a communication fault or crosstalk due to the interference of light. An optical wireless LAN connection using safe and reliable visible light communication is thus possible.

Moreover, the LED 204 is capable of displaying sufficient brightness for the LED lighting by means of a bias current which is supplied by the light modulation unit 203. The LED 204 also has a long lifespan in comparison with an incandescent lamp and is capable of making a contribution toward lower power consumption. In addition, because a green LED, a blue LED, and a white LED are integrally provided in the LED 204 in addition to a red LED, the LED lighting can possess color rendering.

Moreover, by implementing a 10 Mbit/s LAN connection, the work environment is one in which a plurality of people are able to communicate at the same time, a close link can be established between a plurality of workers, and work efficiency improves. Moreover, because the signal processing for the LAN connection is handled by the optical wireless LAN device 2, simplification of the information processing by the terminal device 3 is straightforward, the processing speed is high, and a high usage range can be obtained.

Moreover, this embodiment establishes visible light communication via a downlink and infrared communication via an uplink. There is therefore no light interference and little crosstalk while sending and receiving signals. In addition, because the downlink carries visible light, the communication range can be confirmed by the naked eye and, in comparison with cases where the downlink carries infrared light, the user of the terminal device 3 is able to suitably identify the communication range.

### (4) Further Embodiments

The present invention is not limited to the above embodiment. The shape and dimensions of each member, the number installed, and the LED wavelengths and the like can be suitably modified. The present invention also includes embodiments such as the following embodiment. For example, although the above embodiment established infrared communication via an uplink, both the uplink and the downlink can be used for visible light communication. In this case, it is desirable to avoid communication faults and crosstalk due to light interference by separating the frequencies of the visible light used for each link as much as possible within the spectrum of visible light.

1. A visible light communication system that has an optical wireless LAN device which performs visible light communication with a terminal device by using visible light from an LED lighting unit, comprising:
the optical wireless LAN device having
a light modulation unit which supplies an electric current to the LED lighting unit and
a visible light transmission unit which transmits communication data for transmission and reception to the light modulation unit; and
the LED lighting unit having incorporated therein
a red LED which performs visible light communication by going on and off and
an LED which uses a wavelength which does not interfere with a wavelength used by the red LED.

2. The visible light communication system according to claim 1, wherein the LED lighting unit integrally has the red LED, a green LED, a blue LED, and a white LED.

3. The visible light communication system according to claim 1, wherein a 10 Mbit/s LAN connection is implemented by causing the red LED to go on and off.

4. The visible light communication system according to claim 1, wherein, in the data exchange between the terminal device and the optical wireless LAN device, a downlink is established by means of visible light communication and an uplink is established by means of infrared communication.

5. The visible light communication system according to claim 1, wherein the terminal device and the optical wireless LAN device comprise a light-receiving element used to detect a spatial carrier, and in cases where it is confirmed by the light-receiving element that a spatial carrier does not exist, the terminal device and the optical wireless LAN device transmit and receive communication data.

6. An optical wireless LAN device comprising, as a lighting unit, an LED in which a red LED, a green LED, a blue LED, and a white LED are integrated,
wherein the optical wireless LAN device performs visible light communication by causing the red LED to go on and off.
